(19) United States
(12) Patent Application Publication
(10) Pub. No.: US 2002/0191950 A1
(43) Pub. Date: Dec. 19, 2002

(54) Apparatus and a method for preventing commercial skipping

(76) Inventor: Xiaoling Wang, Princeton Junction, NJ (US)

Correspondence Address: Mr. Walter J. Tencza Jr., Suite 3, 10 Station Place, Metuchen, NJ, 08840, US

(21) Appl. No.: 09/882,218

(22) Filed: Jun. 15, 2001

(51) Int. Cl. H04N 7/00; H04N 5/76

(52) U.S. Cl. 386/46; 348/907; 358/908

(57) ABSTRACT

A system, apparatus, and method according to the present invention can enable or disable all manual and automated skipping functions of a video recording and playback device based on a content classification signal which is associated with a video signal. The content classification signal may be comprised of a plurality of portions each of which indicate whether commercial or non-commercial content is in a particular portion of a video signal. The manual and automated skipping functions may include all functions that allow fast forward with and without video content display, fast forward with different speeds, fast forward with varying speed, one-button skipping functions with at least one preset skipping time or length interval, and smart skipping functions that skip only to a certain end point set automatically or manually. The system and the method according to the present invention offers also flexible possibilities to selectively disable or enable the skipping functions based on a set of management parameters such as television channel identification, television program identification, television program class identification, date and time identification, as well as subscription related information. In addition, the system and the method according to the present invention provides a user-definable content classification signal in a content description file which is associated with the video signal to form the video plus content classification signal.

### FIELD OF THE INVENTION

This invention relates to the field of systems, methods, and apparatus for playing back television programs and commercials.

### BACKGROUND OF THE INVENTION

Television (TV) broadcasters generally have to sell television commercials to support acquisition and broadcasting of regular TV programs. The TV commercials are typically inserted into the regular TV programs and broadcasted at certain time intervals so that the television viewers who are interested in watching regular TV programs also watch inserted TV commercials.

On the other hand, many viewers of commercially broadcast TV programs wish to view regular TV programs without TV commercials. The most commonly used method for skipping TV commercials is the manual fast forward operation supported by all Video Cassette Recorders (VCRs) and Digital Video Recorders (DVRs) when playing recorded TV programs. With the growing popularity of DVRs from TiVo (trademarked), Replay TV (trademarked), and Ultimate TV (trademarked), that are very convenient to record and replay TV programs with no visible quality losses, more TV viewers tend to record their favorite TV programs first and view them at their convenience later. Because of the nature of digital recording, recorded TV commercials can be skipped very fast and easily. This leads to serious challenges to the TV content providers and broadcasters who are currently dependent on selling effective TV commercials for supporting their content creation and broadcasting. If the effectiveness of the current TV commercial broadcasting model is challenged due to broad adoption and usage of manual and/or automated commercial skipping, the TV content providers and broadcasters might be forced to move to other revenue collection models. However, if systems and methods can be developed and used to prevent manual and/or automated skipping during commercials, TV content owners and broadcasters will be able to provide high quality TV programs without the need to switch to other revenue collection models.

There have been many prior art systems and methods for providing some automated content classification devices for detecting and eliminating TV commercials. All known prior art in the field of television commercial detection and elimination systems, as described in the U.S. Pat. Nos. 4,319,286 to Hanpachern, 4,750,052 to Poppy and Samelson, 4,752,834 to Koombes, 5,333,091 to Iggulden and McFarland, 5,692,093 to Iggulden at. al, and 5,986,866 also to Iggulden at. al, rely on some sort of automated signal analysis capabilities to detect the commercials within regular television program contents. All of these patents are incorporated by reference herein.

All prior art methods and systems implement automated television commercial detection schemes based on some signals that are typical to commercials, such as blank or black video frames, blank video frames followed by “active scenes”, blank frames followed by another blank frame with a certain timing interval that is typical to commercials, or low audio signals with dark video frames. There is one automated solution available today for television commercial detection and elimination sold in the United States market. The solution, called “Commercial Advance” (trademarked), is mainly based on the systems and methods disclosed in the following U.S. Pat. Nos. 5,333,091, 5,692,093, 5,986,866, all by Iggulden at. Al.

### SUMMARY OF THE INVENTION

The present invention is designed to provide a system, an apparatus, and a method that can effectively prevent manual and/or automated skipping of television commercials.

The present invention in one or more embodiments provides a solution that can effectively prevent manual and automated skipping of television commercials while playing a recorded television video on a video recording and playback device.

A system, apparatus, and method according to the present invention can disable all manual and automated skipping functions of a video recording and playback device when commercials are playing. The manual and automated skipping functions may include all functions that allow fast forward with and without video content display, fast forward with different speeds, fast forward with varying speed, one-button skipping functions with at least one preset skipping time or length interval, and smart skipping functions that skip only to a certain end point set automatically or manually.

Furthermore, a system and a method according to the present invention offers flexible possibilities to selectively disable or enable the skipping functions based on a set of skipping management parameters which may include TV channel identification, TV program identification, TV program class identification, date and time, allowed maximum count of commercial skips for a given period of time, as well as subscription related information. The system can for example be configured to prevent the commercial skipping only for certain TV channels and TV programs, on certain dates and at certain times. The system can also be configured to allow a user to skip commercials for any channel or program as long as the currently used credit points of commercial skips is smaller than the allowed credit points of commercial skips for a given period of time. The system can further be configured to make the skipping prevention function dependent on the level and status of service subscriptions.

### BRIEF DESCRIPTION OF THE DRAWINGS

FIG. 1 is a general block diagram schematic illustrating the structure of a first embodiment of the present invention; and

FIG. 2 is a general block diagram schematic illustrating the structure of a second embodiment of the present invention, which includes the use of a set of management parameters; and

FIG. 3 is a general block diagram schematic illustrating the structure of a third embodiment of the present invention, which operates only based on a set of management parameters without the influence of a content classification signal;

FIG. 4 is a general block diagram schematic illustrating the structure of a fourth embodiment of the present invention, which is similar to the first embodiment but includes a video plus content classification signal reading and decryption device that reads and decrypts the content classification signal;

FIG. 5 is a general block diagram schematic illustrating the structure of a fifth embodiment of the present invention, which is similar to the second embodiment but includes a video plus content classification signal reading and decryption device that reads and decrypts the content classification signal;

FIG. 6 is a general block diagram schematic illustrating the structure of a sixth embodiment of the present invention, which is similar to the fifth embodiment but includes a video plus content classification signal creation device that creates a video plus content classification signal from a video signal;

FIG. 7 is a general block diagram schematic illustrating the structure of a seventh embodiment of the present invention, which is similar to the second embodiment but includes a device which creates a content classification signal from a video signal;

FIG. 8A is a general block diagram schematic illustrating the creation of a video plus content classification signal from a video signal using an automated content classification device and a content classification output and encryption device;

FIG. 8B is a general block diagram schematic illustrating the creation of a video plus content classification signal from a video signal using a manual content classification device and a content classification output and encryption device;

FIG. 8C is a general block diagram schematic illustrating the creation of a video plus content classification signal using an automated content classification device, a manual content classification device, and a content classification output and encryption device;

FIG. 8D is a general block diagram schematic illustrating the creation of a video plus content classification signal using a content editing and composition device and a content classification output and encryption device; and

FIG. 8E is a general block diagram schematic illustrating the creation of a video plus content classification signal from a video signal and its corresponding content classification signal using a content classification output and encryption device.

### DETAILED DESCRIPTION OF THE INVENTION

The present invention in one or more embodiments provides a solution that can effectively prevent manual and/or automated skipping of television commercials when a recorded television video or video signal is playing on a video recording and playback device.

All data busses or connections described in the present application, such as by input and output lines can be wired and/or wireless busses or a combination of them. These busses or connections can further be one-way or bi-directional data transferring busses and/or functional and/or logical connections. All devices described in the present application can be implemented with a computer programmed with computer software or may include computer or electronic circuitry which may be programmed through electronics hardware or computer software. All of the devices in various embodiments may actually reside in the same computer such that one computer functions as multiple devices or all of the devices of a particular embodiment. All of the devices in various embodiments may also be implemented with electronic circuitry, processors, static and dynamic memory devices within a system such that they function as multiple devices or all of the devices of a particular embodiment.

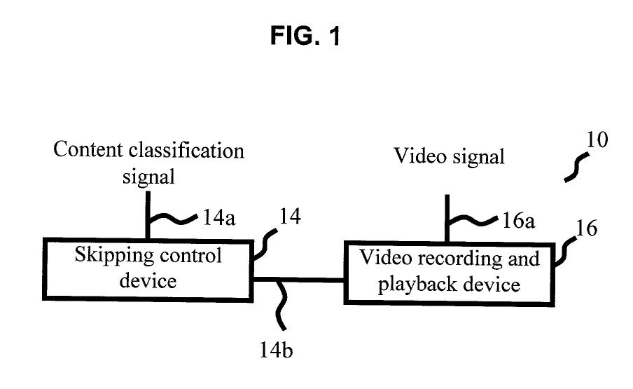

A block diagram of a system, apparatus, and method according to one embodiment of the present invention is shown in FIG. 1. FIG. 1 shows apparatus 10 comprised of a skipping control device 14 and a video recording and playback device 16. The skipping control device 14 is connected by a bus 14b to video recording and playback device 16. The skipping control device 14 is connected to a bus 14a and the video recording and playback device 16 is connected to a bus 16a.

In operation, referring to FIG. 1, a video signal and its corresponding content classification signal are input via the bus 16a and the bus 14a into the video recording and playback device 16 and into the skipping control device 14, respectively. The video signal may actually be comprised of many video signal portions and the content classification signal may also actually be comprised of many content classification signal portions. Each portion of the video signal may have an associated or related portion of the content classification signal.

The skipping control device 14 sends control signals through the bus 14b to the video recording and playback device 16 for disabling or enabling one, a plurality of, or all of the manual and automated skipping functions of the video recording and playback device 16. Whether various manual or automated skipping functions will be disabled or enabled depends on the content classification signal provided via bus 14a. The common manual and automated skipping functions of a video recording and playback device, such as device 16, may include all functions that allow fast forward with and without video content display, fast forward with different speeds, fast forward with varying speed, one-button skipping functions with at least one preset skipping time or length interval, and smart skipping functions that skip only to a certain end point set automatically or manually.

If the skipping control device 14 determines that the content classification signal indicates that a current portion of the video signal is not a commercial, i.e. has regular content, then the device 14, in one embodiment, enables all manual and automated skipping functions of the video recording and playback device 16. This allows a user of the system including the video recording and playback device 16 to fast forward regular, non-commercial video content.

If the skipping control device 14 determines that the content classification signal indicates that the current portion of the video signal has commercial content then the device 14, in one embodiment, disables all manual and automated skipping functions of the video recording and playback device 16. This prevents a user of the system including the video recording and playback device 16 from fast forwarding a commercial, for example.

When the manual and automated skipping functions of the video recording and playback device 16, such as a manual fast forward function, are disabled, these functions cannot be accessed from a control panel or a remote control device of the video recording and playback device 16. In this disabled state, if a user presses a manual fast forward button, the video recording and playback device 16 does not execute the manual fast forward function and may provide a short indication that this function is temporarily disabled during the playback of a commercial.

If a user presses a manual fast forward button when a video portion containing regular content is playing, the requested action may be performed by the video recording and playback device 16. The skipping control device 14 will send a disable control signal to device 16 only when the beginning of a commercial has been reached. Upon receiving the disable control signal, the video recording and playback device 16 may either stop the fast forwarding action at the beginning of the coming commercial or automatically switch to the play mode to start playing back the commercial. In the later case, device 16 will play back all of the following commercials until the beginning of the next regular content portion has been reached and switch back to the fast forwarding mode.

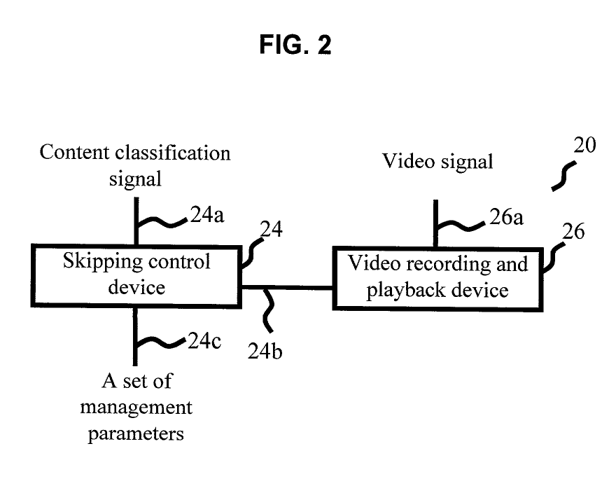

FIG. 2 shows a second embodiment in accordance with the present invention. FIG. 2 shows apparatus 20 which is comprised of a skipping control device 24 and a video recording and playback device 26. Device 26 may be similar to device 16 of FIG. 1. The skipping control device 24 is connected by a bus 24b to the video recording and playback device 26. Device 24 is connected to a bus 24a and device 26 is connected to a bus 26a. Device 24 also has a bus 24c. Devices 24, and 26 may be connected to one another similarly to devices 14 and 16 of FIG. 1.

The operation of the apparatus 20 of FIG. 2 may be somewhat similar to that of the apparatus 10 of FIG. 1. However, unlike the apparatus of FIG. 1, the skipping control device 24 of FIG. 2 includes a bus 24c, through which a set of management parameters can be input in accordance with a second embodiment of the present invention.

A system and a method according to the present invention can further provide flexible possibilities for selectively disabling and enabling the skipping functions of the video recording and playback device 26 of FIG. 2 based on a set of management parameters which can be provided via bus 24c. The skipping control device 24 may receive in addition to the content classification signal through bus 24a, a set of skipping management parameters through the bus 24c. The set of skipping management parameters may include some of but not limited to the following parameters:

(a) Skipping management mode including but not limited to the following modes:

a. Selected channels only (the commercials on these selected channels, such as ABC (trademarked), CNN (trademarked), Discovery (trademarked), TLC (trademarked), for example, can or cannot be skipped);

b. Selected TV program only (the commercials aired with these selected TV programs, such as Dateline (trademarked), 60 Minutes (trademarked), Friends (trademarked), Seinfeld (trademarked), can or cannot be skipped);

c. Selected TV program class only (the commercials aired with these selected TV program classes, such as Movie and News, can or cannot be skipped);

d. Selected date only (the commercials aired on these selected dates, such as weekdays, or weekends, or Mondays and Wednesdays, can or cannot be skipped);

e. Selected time only (the commercials aired between certain times, such as after 6 PM and before 9 PM, can or cannot be skipped)

f. Credit point only; and

g. Combinations of the above modes;

(b) Skipping management mode related information such as which channels, which programs, which TV program classes, which date and time, etc, depending on the selected skipping management mode;

(c) TV channel identification;

(d) TV program identification;

(e) TV program class identification (such as News, Sports, Movies, Drama, Action, Comedy, Mystery, Children, Educational, MTV (trademark, stands for Music Television), Talk shows, Sci-Fi, Soaps, etc.);

(f) Allowed credit points of commercial skips for a given period of time;

(g) Currently used credit points of commercial skips for a given period of time;

(h) Date;

(i) Time; and

(j) Subscription related information, such as subscription identification, subscription level which may also be identified from the subscription identification, and subscription status.

The system and apparatus 20 as shown in FIG. 2 can easily be configured to selectively prevent the commercial skipping for certain TV channels and/or certain TV programs and/or certain TV program class identifications, and/or on certain dates and at certain times. The system can for example be configured to allow or prevent the commercial skipping for all TV contents from Channel 3, 31, 63, or Channel CBS (trademarked), CNN (trademarked), Discovery (trademarked), and/or everything classified as TV program class “Movie” on weekend, and/or all “News” and “Sports” programs from all channels from 6 PM to 11 PM daily.

In addition, the system provides also the flexibility for satisfying a user's own commercial skipping needs. A user can be given an allowed number of credit points of commercial skips and a currently used credit points of commercial skips as two of the skipping management parameters for a given period of time, such as a day, a week, a month, a quarter, or a year. The system may allow the skipping of any commercials as long as the currently used credit points of commercial skips is smaller than the allowed credit points of commercial skips for a given period of time. Once the allowed credit points of commercial skips have been reached for a given period of time, the skipping control device 24 may disable all skipping functions of the video recording and playback device 26 for all channels and programs until the allowed credit points of commercial skips at the beginning of the next given period of time have been issued. In a simplest implementation, the credit points of commercial skips may be equal to the number of skipped commercials. In this case, every TV commercial has been assumed to have the same “value” or “importance”. However, in reality, this assumption may not be optimal. Commercials may have different length, different airtime, and different number of expected audiences based on the attractiveness of the TV program they are aired with. In a more advanced implementation, it is beneficial to recognize that a long commercial might be worth more “credit points of commercial skips” than that of a short one aired with a similar TV program, and a commercial inserted into a popular TV program might be worth more that that one within an unpopular TV program. In this case, some simple rules can be designed to reflect the different value of commercials. For example, we can design the following simple rules based on the length of commercials:

(1) Any commercial with a length less than 16 seconds costs one credit point;

(2) Any commercial with a length between 16 and 30 seconds costs two credit points;

(3) Any commercial with a length between 31 and 60 seconds costs three credit points; and

(4) Any commercial with a length of 61 seconds costs four credit points.

Furthermore, the above-mentioned flexibilities can be offered as a subscription service with one or more levels. For a user who has no time to watch commercials, a high subscription fee can be charged that allows skipping of any commercials from all channels. For a user who does not want to pay a high fee and does not mind watching some commercials, a medium subscription fee can be charged. This allows him to either skip commercials for certain selected channels, programs, dates, and times, or to skip commercials selectively with an allowed number of credit points of commercial skips for a given period of time. For a user who does not want to pay anything or just pay a minimum fee, the system may not allow the skipping of any commercials for most channels. If a user has an invalid or suspended subscription, the system may also prevent him from skipping any commercials. Therefore, the system can also be configured to make the skipping prevention function dependent on the level and status of service subscriptions.

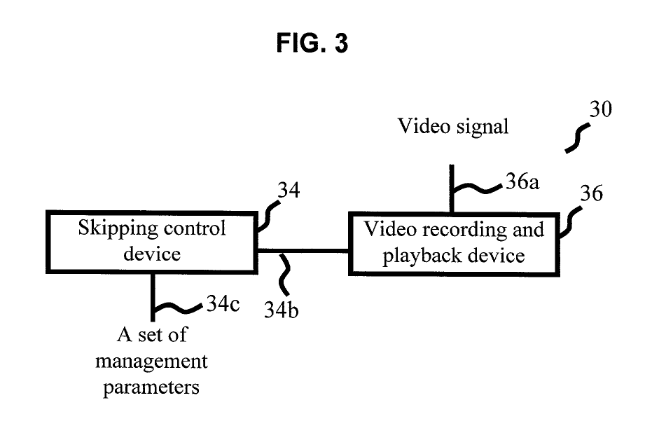

The present invention in one of its simplest embodiments further provides the possibility for disabling all manual and automated skipping functions. In this particular embodiment, all manual and automated skipping functions may be disabled independent of the content of a playing video signal, as shown in FIG. 3.

FIG. 3 shows a third embodiment in accordance with the present invention. FIG. 3 shows apparatus 30 which is comprised of a skipping control device 34 and a video recording and playback device 36. Device 36 may be similar to device 26 of FIG. 2. Device 34 is connected to device 36 by a bus 34b. A bus 34c is connected to skipping control device 34 and a bus 36a is connected to video recording and playback device 36.

The operation of the apparatus 30 of FIG. 3 may be somewhat similar to that of the apparatus 20 of FIG. 2. However, unlike the apparatus of FIG. 2, the skipping control device 34 of FIG. 3 does not take the content classification signal as input any more in accordance with a third embodiment of the present invention. The skipping control device 34 takes a set of management parameters via bus 34c as input and sends enabling or disabling signals to the video recording and playback device 36 via bus 34b only based on the input management parameters. The management parameters may be similar to those described in the previous sections. The main advantage of this embodiment is its simplicity and effectiveness for commercial skipping prevention without a content classification signal. Since the embodiment works with a set of management parameters, it may be configured to have similar flexibilities provided by the second embodiment shown in FIG. 2. For example, the apparatus may be configured to prevent manual and automated skipping functions for selected channels, such as Channel CBS (trademarked), CNN (trademarked), Discovery (trademarked), and/or for certain times and dates, such as some selected channels on weekend, and/or all channels from 6 PM to 11 PM daily. Because this embodiment does not take video contents into consideration, all video content related management parameters as described in the second embodiment will not have any effects and will be ignored.

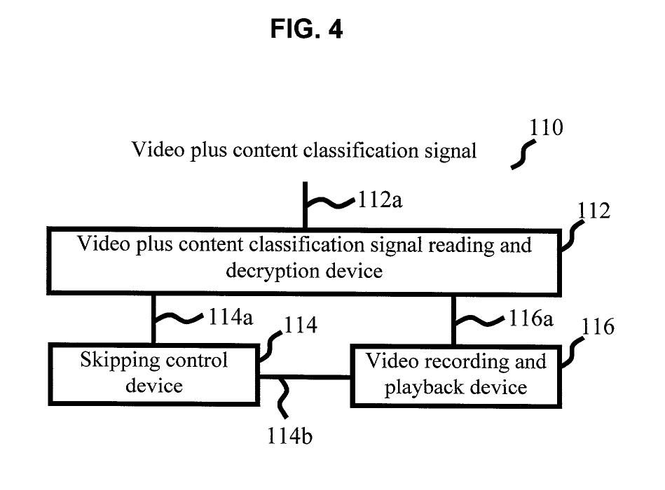

FIG. 4 shows a fourth embodiment in accordance with the present invention. FIG. 4 shows apparatus 110 which is comprised of a video plus content classification signal reading and decryption device 112, a skipping control device 114, and a video recording and playback device 116. The video plus content classification signal reading and decryption device 112 has a bus 112a and is connected by a bus 114a to the skipping control device 114. The device 112 is also connected to the video recording and playback device 116 by a bus 116a. The skipping control device 114 is connected by a bus 114b to video recording and playback device 116.

In operation, referring to FIG. 4, a video plus content classification signal is input via the bus 112a into the video plus content classification signal reading and decryption device 112. The video plus content classification signal is comprised of a typical video signal and a content classification signal. The video signal may actually be comprised of many video signal portions and the content classification signal may also actually be comprised of many content classification signal portions. Each portion of the video signal may have an associated or related portion of the content classification signal. The video plus content classification signal reading and decryption device 112 determines and extracts the content classification signal from the video plus content classification signal and passes the content classification signal through the bus 114a to the skipping control device 114. The video plus content classification signal reading and decryption device 112 also extracts the video signal and supplies the video signal to the video recording and playback device 116 via bus 116a. Device 114 and 116 may be similar to device 14 and 16 of FIG. 1. After the content classification signal and the video signal are extracted and supplied to devices 114 and 116 via bus 114a and 116a, respectively, the apparatus 110 operates similarly to the first embodiment shown in FIG. 1.

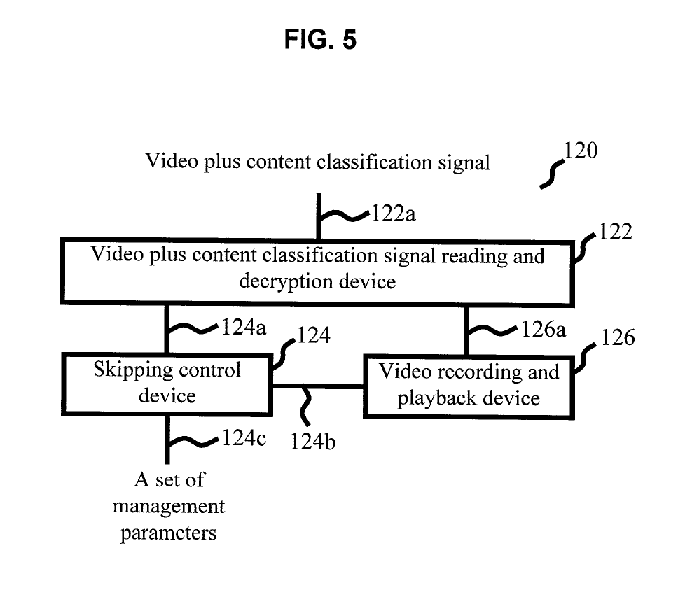

FIG. 5 shows a fifth embodiment in accordance with the present invention. FIG. 5 shows apparatus 120 which is comprised of a video plus content classification signal reading and decryption device 122, a skipping control device 124, and a video recording and playback device 126. Devices 122,124, and 126 may be similar to devices 112, 114, and 116 of FIG. 4. The video plus content classification signal reading and decryption device 122 has a bus 122a or is connected to a bus 122a and is connected by a bus 124a to the skipping control device 124. The device 122 is also connected to video recording and playback device 126 by a bus 126a. The skipping control device 124 is connected by a bus 124b to the video recording and playback device 126. Device 124 also has a bus 124c or is connected to a bus 124c. Devices 122,124, and 126 may be connected to one another similarly to devices 112,114, and 116 of FIG. 4.

The operation of the apparatus 120 of FIG. 5 may be somewhat similar to that of the apparatus 110 of FIG. 4. However, unlike the apparatus of FIG. 4, the skipping control device 124 of FIG. 5 includes a bus 124c. The bus 124c can be used to input a set of management parameters in accordance with a fifth embodiment of the present invention. The set of management parameters may be similar to those used by the second embodiment. After the content classification signal and the video signal are extracted and supplied to devices 124 and 126 via bus 124a and 126a, respectively, the apparatus operates similarly to the second embodiment shown in FIG. 2.

A video plus content classification signal described in the previous sections concerning the fourth and fifth embodiments of the present invention can in general take one of the following two basic forms:

(1) The content classification signal can be embedded in the overall video plus content classification signal; or

(2) The content classification signal can be a distinctly separate entity from the video signal in the overall video plus content classification signal.

The first form generally stores content classification information in terms of markings or flags that indicate the beginning and the end locations of all regular content portions (i.e. non-commercial) and commercials within a video plus content classification signal. These markings or flags are easily identifiable and stored within the video plus content classification signal in such a way that the visual and audio part of the original video signal is not modified.

The second form, wherein the content classification signal is a distinctly separate entity within the overall video plus content classification signal is in general more suitable for systems that contain a file reading/writing and management system. The content classification signal may take the form of a content classification description file. A typical content classification description file may be comprised of a file header including but not limited to content owner, content creation date, content modifications, broadcasting related information such as airtime, length of the content, and possibly how many and which commercials as well as their equivalent worth of the “credit points of commercial skips”, along with other needed information, and a file body that exactly describes the content of the video signal in terms of the beginning and the end locations of all regular content sessions and commercials within the video signal. The video plus content classification signal reading and decryption devices 112 and 122 (all of which may be the same) as shown in FIGS. 4-5, are designed in such a way that they can read the content classification signal in either form, i.e. embedded or separate and distinct. In the following descriptions of the invention, we will refer to both content classified video forms as video plus content classification signal for convenience.

In order to avoid any unintended access and usage of the content classification information, the video plus content classification signals including both video signal and the content classification signal can be encrypted in such way that only licensed manufacturers will be able to implement a decryption method in their products and only registered users of those products can get a valid key for decrypting the encrypted video plus content classification signals and/or the content classification signals. The encrypted content classification signals relating to video signals can be embedded within the overall video plus content classification signals or stored distinctly and separately in an encrypted content classification description file associated with the video signal. For preventing any unwanted access to the content classification signal or information for unintended purposes, such as automated commercial skipping, it is sufficient to encrypt just the content classification signal as part of the video plus content classification signal. For an encrypted video plus content classification signal, the video plus content classification signal reading and decryption device, such as 112, or 122 may first decrypt the video plus content classification signal before any further processing. If the content classification signal is encrypted in the first and the second embodiment as shown in FIG. 1 and FIG. 2, respectively, a decryption device may be needed. The decryption device may be implemented as a separate device for decrypting the content classification signal and then supplying the decrypted content classification signal to the skipping control device 14 and 24 as shown in FIG. 1 and FIG. 2, respectively. The decryption device may also be implemented as an integrated device of the skipping control device. In this case, the skipping control device will decrypt the encrypted content classification signal internally before making its control decisions based on the decrypted content classification signal.

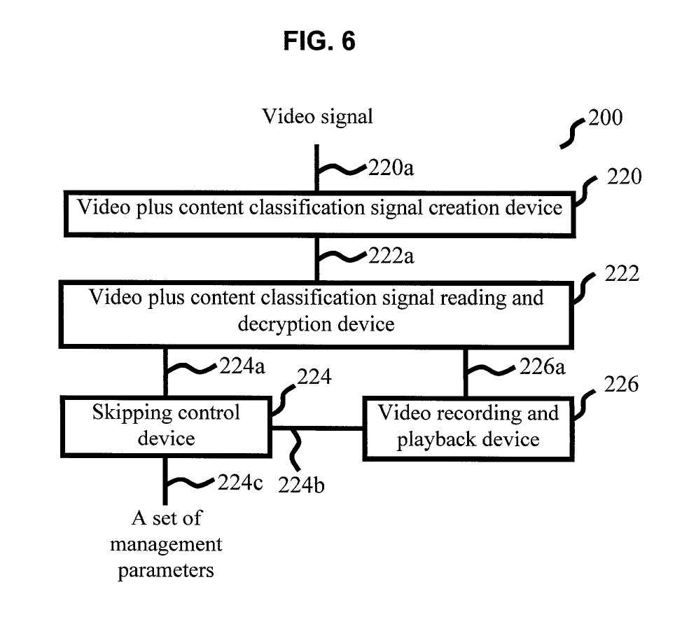

FIG. 6 shows a sixth embodiment in accordance with the present invention. FIG. 6 shows apparatus 200 which is comprised of a video plus content classification signal creation device 220, a video plus content classification signal reading and decryption device 222, a skipping control device 224, and a video recording and playback device 226. Devices 222, 224, and 226 may be similar to devices 122, 124, and 126 of FIG. 5. The video plus content classification signal creation device 220 has a bus 220a and is connected by a bus 222a to the video plus content classification signal reading and decryption device 222. The video plus content classification signal reading and decryption device 222 has a bus 222a and is connected by a bus 224a to the skipping control device 224. The device 222 is also connected to video recording and playback device 226 by a bus 226a. The skipping control device 224 is connected by a bus 224b to the video recording and playback device 226. Device 224 also has or is connected to a bus 224c. Devices 222, 224, and 226 may be connected to one another similarly to devices 122, 124, and 126 of FIG. 5.

The operation of the apparatus 200 of FIG. 6 may be somewhat similar to that of the apparatus 120 of FIG. 5. However, unlike the apparatus 120 of FIG. 5, the input signal in this case is a video signal (not including content classification information) instead of a video plus content classification signal as shown in FIG. 5. The video signal is fed into the video plus content classification signal creation device 220 that can convert a video signal into a video plus content classification signal which can then be fed into the video plus content classification signal reading and decryption device 222 via the bus 222a. The remaining operations are similar to the ones of the fifth embodiment shown in FIG. 5.

A video plus content classification signal can be created from a typical video signal by the video plus content classification signal creation device 220. The device 220 can create and output a video plus content classification signal on bus 222a by for example embedding a content classification signal into the video signal or by supplying the content classification signal separately and distinctly, for example, before or after a defined portion of the video signal or in a separate data file.

Embedding can be done by setting content classification markings or flags into the unclassified video signal. Instead of embedding, a separate content classification description file may be associated with a portion of the video signal.

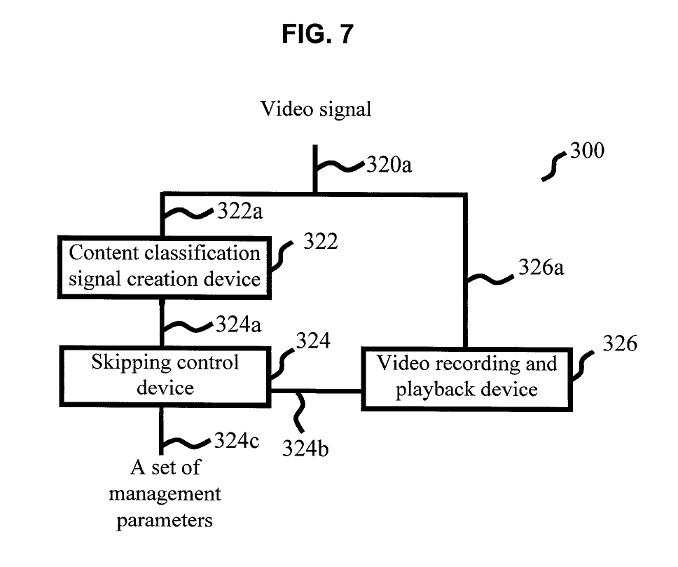

FIG. 7 shows a seventh embodiment in accordance with the present invention. FIG. 7 shows apparatus 300 which is comprised of a content classification signal creation device 322, a skipping control device 324, and a video recording and playback device 326. Devices 324 and 326 may be similar to devices 24, and 26 of FIG. 2.

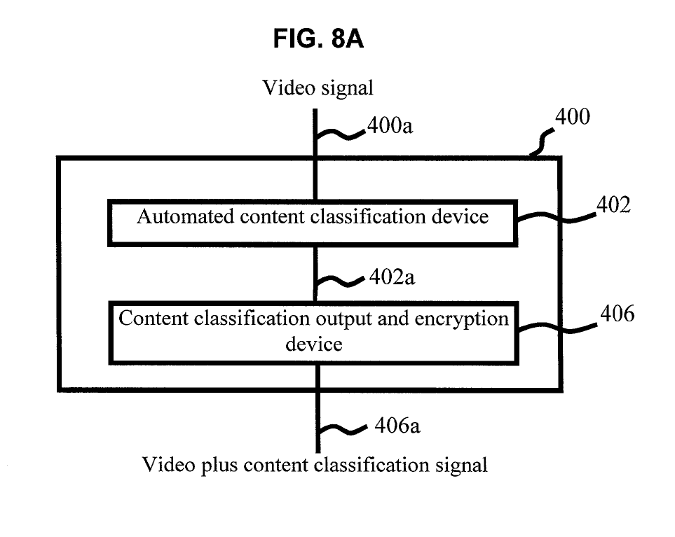

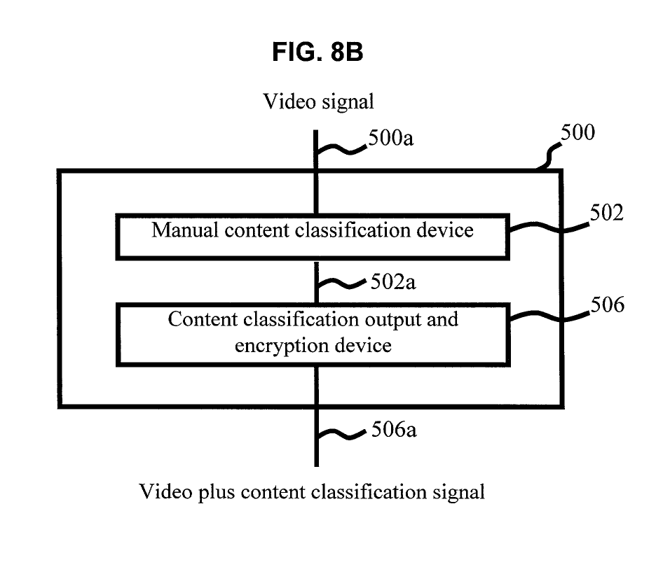

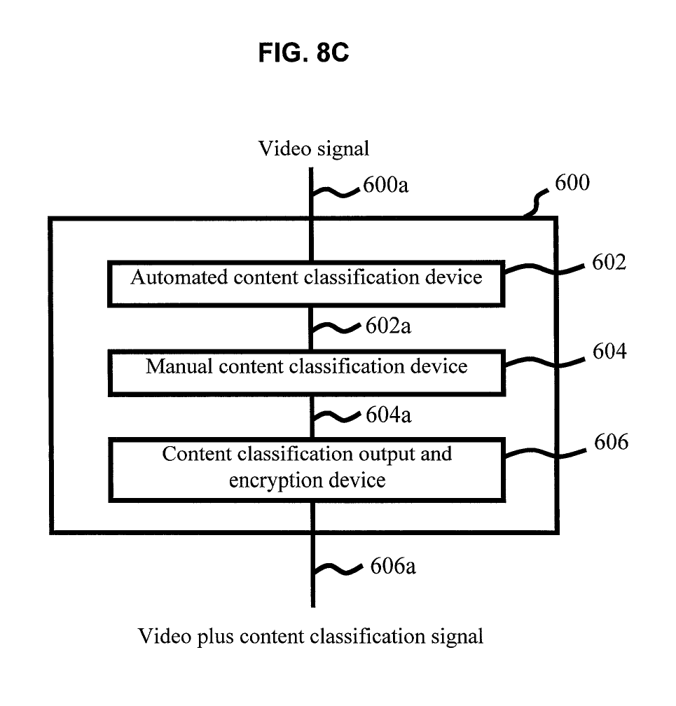

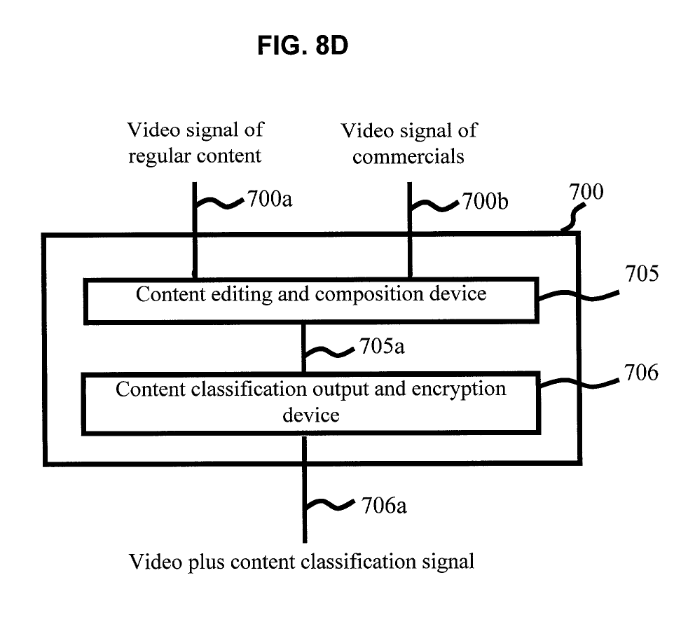

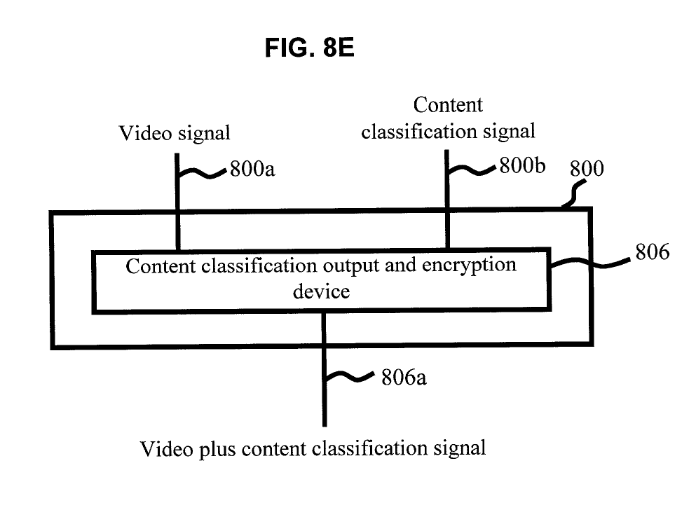

The operation of the apparatus 300 of FIG. 7 may be somewhat similar to that of the apparatus 20 of FIG. 2. However, unlike the apparatus 20 of FIG. 2, the input signal in this case is a video signal (not including content classification information) instead of a video signal and a content classification signal as shown in FIG. 2. The video signal is fed into the video recording and playback device 326 via buses 320a and 326a and the content classification signal creation device 322 that can generate a content classification signal from the video signal via buses 320a and 322a. The content classification signal creation device 322 creates the content classification signal and supplies it to the skipping control device 324 via bus 324a. The remaining operations are similar to the ones of the second embodiment shown in FIG. 2. The content classification signal creation device 322 may generally classify the video content into different classes. In the most common case, however, device 322 may classify a video into the following two typical classes: regular content and commercial. The content classification signal creation device 322 may be implemented similarly to devices 402, 502, and 602 plus 604, as shown in FIGS. 8A-8C, respectively, to be described as follows.

FIG. 8A shows a general block diagram schematic illustrating an apparatus 400 for the creation of a video plus content classification signal from a video signal. The apparatus 400 is comprised of an automated content classification device 402 and a content classification output and encryption device 406. The automated content classification device 402 is connected to a bus 400a and is connected to the content classification output and encryption device 406 by a bus 402a. The content classification output and encryption device 406 is connected to a bus 406a.

In operation, referring to FIG. 8A, a video signal is supplied through the bus 400a to the automated content classification device 402, which automatically classifies the video content into different classes. In the most common case, device 402 may classify a video into the following two typical classes: regular content and commercial. The automated content classification device 402 can employ one of the systems and methods as disclosed and described in U.S. Pat. Nos. 5,333,091, 5,692,093, 5,986,866, all by Iggulden at. Al or a combination of them if needed. These patents are incorporated by reference herein. The automated content classification device 402 supplies the video signal and the content classification signal to the content classification output and encryption device 406 via bus 402a. Device 406 may create a video plus content classification signal from the video signal and the content classification signal by setting content classification markings or flags and embedding them in the video signal to form the video plus content classification signal or by creating one or a plurality of separate content classification description files associated each description file with one or a plurality of portions of the video signal to form a video plus content classification signal. The plurality of content classification description files together can be termed a content classification signal comprised of a plurality of portions.

As shown in FIG. 8B, the video plus content classification signal can also be created by employing a manual content classification device 502 for classifying commercials within a video signal. FIG. 8B shows an apparatus 500 which includes the manual content classification device 502 and a content classification output and encryption device 506. The manual content classification device 502 is connected to a bus 500a and is connected to content classification output and encryption device 506 by a bus 502a. The content classification device 506 is connected to a bus 506a.

In operation, referring to FIG. 8B, a video signal is received on bus 500a. The manual content classification device 502 provides a set of functions to be used by one or more human operators for generating the content classification signal from the video signal manually. The video signal and the content classification signal are then supplied to the content classification output and encryption device 506 which either embeds the content classification signal into the video signal or creates a separate content classification description file to associate with one or more portions of the video signal to provide a video plus content classification signal on bus 506a.

The manual content classification device 502 may be a device operated by one or more human operators. The device 502 may be one or more computers with computer software programs that enable operators to use typical computer peripherals devices, such as keyboard, mouse, joysticks or electronic pen input device, to enter content classification information. Typically, human operators view the video signal to determine if the currently playing content belongs to regular content or commercial. If a commercial has been detected, the operators will use the computer peripherals devices to stop the playing video and rewind it to the exact beginning position of the commercial and enter the classification information. The computer software will record the exact position as well as the entered classification information. After the operators have viewed the whole video signal, the complete content classification signal about this video can be generated. Because human operators can in general better detect all kinds of commercials, the manual content classification device 502 of FIG. 8B as described above has a higher classification accuracy but much slower classification output than the automated content classification device 402 of FIG. 8A.

For increasing the content classification efficiency, a combination of both automated and manual classification devices can be used, as shown in FIG. 8C. FIG. 8C shows apparatus 600 which includes an automated content classification device 602, a manual content classification device 604, and a content classification output and encryption device 606. The automated content classification device 602 is connected to a bus 600a and is connected to the manual content classification device 604 by a bus 602a. The manual content classification device 604 is connected by a bus 604a to the content classification output and encryption device 606. The content classification device 606 is connected to a bus 606a.

In operation, referring to FIG. 8C a video signal is received on bus 600a. The automated content classification device 602 creates a content classification signal automatically and passes the video signal and the content classification signal to the manual content classification device 604 via bus 602a. The manual content classification device 604 reviews and modifies the content classification signal and provides a refined content classification signal and the video signal on bus 604a to the content classification output and encryption device 606 which forms a video plus content classification signal on bus 606a.

With the configuration of FIG. 8C, the automated content classification device 602 will first provide automated classification results on bus 602a. The manual content classification device 604 can use the automated classification results on bus 602a as a starting point and only spend time to do needed refinements and modifications where the content classification signal from the automated content classification device 602 is not accurate. By doing so, accuracy of the content classification can be improved with relatively low manual classification cost because human operators do not need to review the whole video signal.

A video plus content classification signal can also be created and provided by the content owner or the content broker or the broadcaster of a TV program. Since the content owner or the content broker or the broadcaster may be responsible for editing a TV program by inserting commercials for broadcasting, they have in general concrete knowledge about the regular program content and the inserted commercials. In this case, automated and manual content classification devices may not be necessary. In contrast, an editing tool may be useful, as shown in FIG. 8D.

FIG. 8D shows an apparatus 700 which includes a content editing and composition device 705 and a content classification output and encryption device 706. The content editing and composition device 705 is connected to a bus 700a for receiving a video signal with regular content and to a bus 700b for receiving a video signal with commercials, and is connected to content classification output and encryption device 706 by a bus 705a. The content classification output and encryption device 706 is connected to a bus 706a. Devices 705 and 706 may be implemented as one integrated computer program or separate computer programs running on one or more computers. Device 705 enables an operator to use typical computer peripherals devices, such as keyboard, mouse, joysticks or electronic pen input device, to edit and compose a combined video with both regular contents and commercials.

In operation, referring to FIG. 8D a video signal of regular content and a video signal of commercials is received on bus 700a and bus 700b, respectively. The content editing and composition device 705 allows operators to easily put commercials into commercial groups and insert the commercial groups into the regular content with some predetermined time intervals. Each commercial group containing one or more commercials may have a typical length of 1-5 minutes. After the commercial group insertion, the content editing and composition device 705 outputs the combined video with both regular content and commercials and the content classification signal to the content classification output and encryption device 706 via bus 705a. The content classification output and encryption device 706 forms a video plus content classification signal on bus 706a based on the supplied video signal and the content classification signal from bus 705a.

If both the video signal and its content classification signal are known, it is straightforward to create a video plus content classification signal, as shown in FIG. 8E.

FIG. 8E shows an apparatus 800 which includes only a content classification output and encryption device 806. The content classification output and encryption device 806 is connected to a bus 800a for receiving a video signal and to a bus 800b for receiving a content classification signal, and outputs a video plus content classification signal on bus 806a.

In order to avoid any unintended access and usage of the content classification information, the video plus content classification signals including both the video signal and the content classification signal can be encrypted by the content classification encryption and output device 406, 506, 606, 706, and 806 as shown in FIGS. 8A-8E, respectively. The encryption can be designed in such way that only licensed manufacturers will be able to implement a decryption method in their products and only registered users of those products can get a valid key for decrypting the encrypted video plus content classification signals and/or the content classification signals.

I claim:

1. An apparatus comprising
a skipping control device; and
a video recording and playback device including skipping functions;
wherein the video recording and playback device receives a video signal;
and wherein the skipping control device receives a content classification signal and uses it to determine whether to send a control signal to the video recording and playback device, wherein the control signal affecting operation of the skipping functions of the video recording and playback device.

2. The apparatus of claim 1 wherein
the control signal disables the skipping functions of the video recording and playback device.

3. The apparatus of claim 1 wherein
the control signal enables the skipping functions of the video recording and playback device.

4. The apparatus of claim 1 wherein
the skipping control device receives a first management parameter; and
wherein the skipping control device uses both the content classification signal and the first management parameter to determine whether to send the control signal to the video playback and recording device.

5. The apparatus of claim 4 wherein
the skipping control device receives a plurality of management parameters; and
wherein the skipping control device uses both the content classification signal and the plurality of management parameters to determine whether to send the control signal to the video playback and recording device.

6. An apparatus comprising
a skipping control device; and
a video recording and playback device including skipping functions;
wherein the video recording and playback device receives a video signal;
and wherein the skipping control device receives a first management parameter and uses it to determine whether to send a control signal to the video recording and playback device, wherein the control signal affects operation of the skipping functions of the video recording and playback device.

7. The apparatus of claim 6 wherein
the skipping control device receives a plurality of management parameters; and
wherein the skipping control device uses the plurality of management parameters to determine whether to send the control signal to the video playback and recording device.

8. An apparatus comprising
a video plus content classification signal reading and decryption device;
a skipping control device; and
a video recording and playback device including skipping functions;
wherein the video plus content classification signal reading and decryption device receives a video plus content classification signal;
extracts a video signal from the video plus content classification signal;
extracts a content classification signal from the video plus content classification signal;
supplies the video signal to the video recording and playback device; and
supplies the content classification signal to the skipping control device;
and wherein the skipping control device uses the content classification signal to determine whether to send a control signal to the video recording and playback device, wherein the control signal affecting operation of the skipping functions of the video recording and playback device.

9. The apparatus of claim 8 wherein
the skipping control device receives a first management parameter; and
wherein the skipping control device uses both the content classification signal and the first management parameter to determine whether to send the control signal to the video playback and recording device.

10. The apparatus of claim 9 wherein
the skipping control device receives a plurality of management parameters, and
wherein the skipping control device uses both the content classification signal and the plurality of management parameters to determine whether to send the control signal to the video playback and recording device.

11. The apparatus of claim 1 wherein
the control signal disables the skipping functions of the video recording and playback device when a portion of the content classification signal indicates that a related portion of the video signal has commercial content, and the control signal enables the skipping functions of the video recording and playback device when a portion of the content classification signal indicates that a related portion of the video signal has regular content.

12. The apparatus of claim 4 wherein
the first management parameter identifies a television channel.

13. The apparatus of claim 4 wherein
the first management parameter identifies a television program.

14. The apparatus of claim 4 wherein
the first management parameter identifies a television program classification.

15. The apparatus of claim 4 wherein
the first management parameter identifies a date that the video signal was recorded.

16. The apparatus of claim 4 wherein
the first management parameter identifies a time that the video signal was recorded.

17. The apparatus of claim 4 wherein
the first management parameter identifies a user subscription to a service.

18. The apparatus of claim 4 wherein
the first management parameter identifies a user subscription level to a service.

19. The apparatus of claim 5 wherein
the plurality of parameters are comprised of
an allowed number of credit points of commercial skips for a given period of time;
a currently used number of credit points of commercial skips for a given period of time.
wherein if the allowed number of credit points of commercial skips for a given period of time is greater than the currently used number of credit points of commercial skips for a given period of time then the control signal enables the skipping functions of the video recording and playback device when the content classification signal indicates that the video signal includes commercial content

20. The apparatus of claim 5 wherein
the plurality of parameters are comprised of
a complete disabling parameter that causes the skipping control device to completely disable the skipping functions of the video playback and recording device independent of the content classification signal.

21. A method comprising the steps of:
receiving a content classification signal relating to the content of a video signal and using it to determine whether to send a control signal to a video recording and playback device having skipping functions; and
sending the control signal to the video recording and playback device;
wherein the control signal affects skipping functions of the video recording and playback device.

22. The method of claim 21 wherein
the control signal disables the skipping functions of the video recording and playback device.

23. The method of claim 21 wherein
the control signal enables the skipping functions of the video recording and playback device.

24. The method of claim 21 further comprising
receiving a first management parameter; and
using both the content classification signal and the first management parameter to determine whether to send the control signal to the video playback and recording device.

25. The method of claim 24 further comprising
receiving a plurality of management parameters; and
using both the content classification signal and the plurality of management parameters to determine whether to send the control signal to the video playback and recording device.

26. A method comprising the steps of
receiving a video signal;
receiving a first management parameter and using it to determine whether to send a control signal to a video recording and playback device having skipping functions; and
sending the control signal to the video recording and playback device;
wherein the control signal affects operation of the skipping functions of the video recording and playback device.

27. The method of claim 26 further comprised of the steps of
receiving a plurality of management parameters; and
using the plurality of management parameters to determine whether to send the control signal to the video playback and recording device.

28. A method comprising the steps of
receiving a video plus content classification signal;
extracting a video signal from the video plus content classification signal;
extracting a content classification signal from the video plus content classification signal;
supplying the video signal to a video recording and playback device, having skipping functions; and
supplying the content classification signal to a skipping control device;
and wherein the skipping control device uses the content classification signal to determine whether to send a control signal to the video recording and playback device, wherein the control signal affecting operation of the skipping functions of the video recording and playback device.

29. The method of claim 28 further comprising
receiving a first management parameter; and
wherein the skipping control device uses both the content classification signal and the first management parameter to determine whether to send the control signal to the video playback and recording device.

30. The method of claim 29 further comprising
receiving a plurality of management parameters; and
wherein the skipping control device uses both the content classification signal and the plurality of management parameters to determine whether to send the control signal to the video playback and recording device.

31. The method of claim 21 wherein
the control signal disables the skipping functions of the video recording and playback device when a portion of the content classification signal indicates that a related portion of the video signal has commercial content, and the control signal enables the skipping functions of the video recording and playback device when a portion of the content classification signal indicates that a related portion of the video signal has regular content.

32. The method of claim 21 wherein
the first management parameter identifies a television channel.

33. The method of claim 21 wherein
the first management parameter identifies a television program.

34. The method of claim 21 wherein
the first management parameter identifies a television program classification.

35. The method of claim 21 wherein
the first management parameter identifies a date that the video signal was recorded.

36. The method of claim 21 wherein
the first management parameter identifies a time that the video signal was recorded.

37. The method of claim 21 wherein
the first management parameter identifies a user subscription to a service.

38. The method of claim 21 wherein
the first management parameter identifies a user subscription level to a service.

39. The method of claim 25 wherein
the plurality of parameters are comprised of
an allowed number of credit points of commercial skips for a given period of time;
a currently used number of credit points of commercial skips for a given period of time;
wherein if the allowed number of credit points of commercial skips for a given period of time is greater than the currently used number of credit points of commercial skips for a given period of time then the control signal enables the skipping functions of the video recording and playback device when the content classification signal indicates that the video signal includes commercial content

40. The apparatus of claim 25 wherein
the plurality of parameters are comprised of
a complete disabling parameter that causes the skipping control device to completely disable the skipping functions of the video playback and recording device independent of the content classification signal.
